(19) United States
(12) Patent Application Publication
(10) Pub. No.: US 2016/0212095 A1
(43) Pub. Date: Jul. 21, 2016

(54) METHOD AND SYSTEM FOR ACCESSING RESOURCE AND SYSTEM APPLYING THE SAME

(71) Applicants: Korea Electronics Technology Institute, Seongnam-si (KR); Industry-Academia Cooperation Group of Sejong University, Seoul (KR)

(72) Inventors: Sung Chan Choi, Seoul (KR); Jae Ho Kim, Yongin-si (KR); Jae Seung Song, Seoul (KR); Sang Shin Lee, Yongin-si (KR); Il Yeup Ahn, Yongin-si (KR); Min Hwan Song, Seoul (KR); Jae Seok Yun, Yongin-si (KR); Kwang Ho Won, Yongin-si (KR)

(21) Appl. No.: 15/084,383

(22) Filed: Mar. 29, 2016

Related U.S. Application Data
(63) Continuation of application No. PCT/KR2014/009627, filed on Oct. 14, 2014.

(30) Foreign Application Priority Data
Oct. 14, 2013 (KR) 10-2013-0122227
Oct. 14, 2014 (KR) 10-2014-0138102

(51) Int. Cl. H04L 29/12; H04W 4/00

(52) U.S. Cl. CPC H04L 61/3085; H04W 4/005

(57) ABSTRACT

A method and system for accessing resource and system applying the same are disclosed. One aspect provides a method of allocating a universal resource identifier (URI) to a resource in a computer network. The method includes additionally allocating, at a hardware server device, a first type of URI to a URI of a first resource. The method also includes allocating, at the hardware server device, a second type of URI to the URI of the first resource.

### CROSS-REFERENCE TO RELATED APPLICATIONS

This application is a continuation application, and claims the benefit under 35 U.S.C. §§120 and 365 of PCT Application No. PCT/KR2014/009627, filed on Oct. 14, 2014, which is hereby incorporated by reference. PCT/KR2014/009627 also claimed priority from Korean Patent Applications Nos. 10-2013-0122227 filed on Oct. 14, 2013 and 10-2014-0138102 filed on Oct. 14, 2014, which are hereby incorporated by reference.

### BACKGROUND

1. Field

The described technology generally relates to a method and system for accessing a resource and a system applying the same.

2. Description of the Related Technology

As information and communication technologies have developed, networking and Internet environments which were established based on computers, such as personal computers or laptop computers, have been changed to operate based on small mobile devices such as smart phones, personal digital assistants (PDAs), and portable multimedia devices.

However, small devices which are capable of calculating, communicating, and networking may be attached to normal things such as meters and thermometers as well as information devices. The small devices attached to things can automatically acquire information on the things or can mutually share the information through communication networks among the things.

Internet of Things (IoT), machine to machine (M2M), and the like refer to a concept and technology which has things connected to a network using communication devices attached to the things or establishes a communication network between things and shares information.

In the above-described network environment, communication networking can be performed person to person, person to thing, or thing to thing, and thus information can be shared among all entities. This may be considered as an essential technical element for evolving into the future ubiquitous information service society.

There is a demand for an M2M system which can optimize information management and sharing, and a method for efficiently managing resources constituting the M2M system.

The “IoT” is defined as “a new information communication infrastructure that connects all kinds of things existing in the world through networks and enables persons and things to communicate with each other anytime and anywhere.” That is, the IoT may be considered as an infrastructure for realizing a ubiquitous space in which things can be connected with one another anytime and anywhere.

To achieve the IoT, all devices should be registered at a discovery service platform to be found, and should be connected with one another to receive services. To achieve this, there is a need for a method for managing resources of a registration and discovery server, and for definition of a system. However, revealing the access addresses of the resources may result in a breach of security, and frequent change of the access addresses accompanied by the dynamic change of the resources may result in user's confusion.

The above information disclosed in this Background section is only to enhance the understanding of the background of the disclosure and therefore it may contain information that does not form the prior art that is already known in this country to a person of ordinary skill in the art.

### SUMMARY OF CERTAIN INVENTIVE ASPECTS

One inventive aspect relates to a method of accessing a resource.

Another aspect is a method of allocating a resource address and accessing a resource of a thing based on the resource address.

Another aspect is a method of allocating an address to a resource and accessing the resource based on the address.

Another aspect is a method of accessing a resource of a thing that includes: receiving a pseudo access address regarding the resource of the thing; and converting the pseudo access address into a real access address.

The pseudo access address may be open to a user terminal, and the receiving may include receiving the open pseudo access address from the user terminal, and the method may further include providing an access path regarding the resource of the thing of the user terminal.

The pseudo access address may be formed of at least one of a thing ID and a resource name provided by the thing.

The method may further include, when a request for discovery of the resource of the thing is received from an application of a user terminal, generating the pseudo access address regarding the resource of the thing which is requested to be discovered, and transmitting the pseudo access address to the user terminal.

The pseudo access address may be an address which is a result of changing a path of the resource of the thing to a pseudonym path.

The pseudonym path may be related to an entirety or a part of the path of the resource of the thing.

The pseudo access address may be generated using an ID of an application which requests an access to the resource of the thing.

Another aspect is a method of allocating a universal resource identifier (URI) to a resource in a computer network, the method comprising: allocating, at a hardware server device, a first type of URI to a first resource; and additionally allocating, at the hardware server device, a second type of URI to the first resource.

In the above method, the first type of URI and the second type of URI identify the first resource. In the above method, the first type of URI comprises a hierarchical URI, and wherein the second type of URI comprises a non-hierarchical URI. In the above method, the hierarchical URI comprises a URI which is based on the chain of child-parent relations. In the above method, the non-hierarchical URI comprises a URI which is not based on the chain of child-parent relations. In the above method, a root of the first type of URI is identical to a root of the second type of URI. In the above method, the first resource is accessed using the first type of URI or the second type of URI. In the above method, the first resource comprises at least one of the following: a node, a gateway, a server, an application, and data.

The above method further comprises: allocating the first type of URI to a second resource; and additionally allocating the second type of URI to the second resource. In the above method, the hardware server device comprises a machine to machine (M2M) platform server. In the above method, allocating the second type of URI comprises converting the first type of URI to a real access address of the first resource to obtain the second type of URI.

Another aspect is a method for accessing a resource in a computer network, the method comprising: acquiring a universal resource identifier (URI) of the resource from a hardware server device; and accessing the resource based on the acquired URI via the computer network, wherein the acquired URI of the resource is a first type of URI or a second type of URI.

In the above method, the first type of URI comprises a hierarchical URI, and wherein the second type of URI comprises a non-hierarchical URI. In the above method, the hierarchical URI comprises a URI which is based on the chain of child-parent relations. In the above method, the non-hierarchical URI comprises a URI which is not based on the chain of child-parent relations. In the above method, a root of the first type of URI is identical to a root of the second type of URI.

Another aspect is a system for allocating a universal resource identifier (URI) to a resource in a computer network, the system comprising: a memory device configured to store a plurality of URIs; and a hardware processor device being in data communication with the memory device and configured to allocate a first type of URI to a first resource and additionally allocate a second type of URI to the first resource.

In the above system, the hardware processor device is further configured to control the memory device to store the allocated first type of URI and second type of URI.

Another aspect is a device for accessing a resource in a computer network, the device comprising: a hardware processor device configured to acquire a universal resource identifier (URI) of the resource from a hardware server device and access the resource based on the acquired URI via the computer network; and a memory device being in data communication with the hardware processor device and configured to store the acquired URI of the resource, wherein the acquired URI of the resource is a first type of URI or a second type of URI.

In the above device, the first type of URI comprises a hierarchical URI which is based on the chain of child-parent relations, and wherein the second type of URI comprises a non-hierarchical URI which is not based on the chain of child-parent relations.

According to at least one of the disclosed embodiments, a resource of a thing is accessed using a pseudo access address, so that security for the access address of the thing can be guaranteed and also inconvenience and confusion can be avoided when a user accesses the resource.

Furthermore, the security can be tightened by bypassing the disclosure of THE access address of the resource of the thing, and the access address can be uniformly provided to the user even when the access address of the resource of the thing is dynamically changed.

### BRIEF DESCRIPTION OF THE DRAWINGS

FIG. 1 is a view illustrating a concept of a method of accessing a resource of a thing according to an exemplary embodiment.

FIG. 2 is a sequence diagram illustrating a method of accessing a resource of a thing according to an exemplary embodiment.

FIG. 3 is a view illustrating a concept of a method of accessing a resource of a thing according to another exemplary embodiment.

FIG. 4 is a sequence diagram illustrating a process of providing a pseudonym path.

FIG. 5 is a view illustrating a concept of a method of accessing a resource of a thing according to another exemplary embodiment.

### DETAILED DESCRIPTION OF CERTAIN INVENTIVE EMBODIMENTS

Hereinafter, embodiments will be described in more detail with reference to the accompanying drawings.

### Method #1 for Accessing Resource of Thing

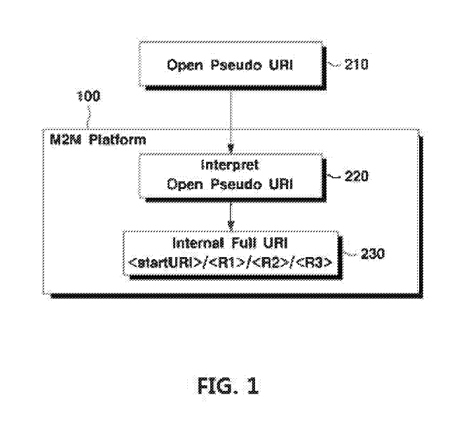

FIG. 1 is a view to illustrate a concept of a method for accessing a resource of a thing according to an exemplary embodiment. The resource of the thing (device) can be accessed using an open pseudo universal resource identifier (URI) 210 which is an open pseudo access address. An example of URI includes a uniform resource locator (URL)

The open pseudo URI 210 may include a unique ID of the thing and a resource name provided by the thing. However, this is merely an example for convenience of explanation and the open pseudo URI 210 may be formed in other ways.

The open pseudo URI 210 may be provided by a developer of the thing (device) or an IoT service provider.

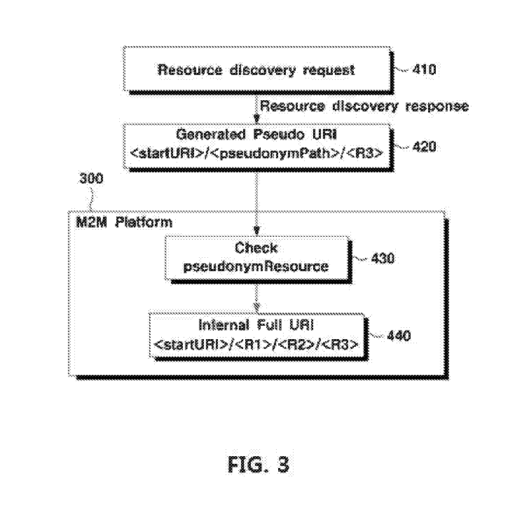

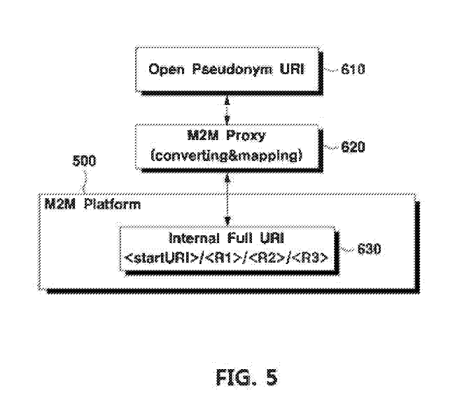

An M2M platform 100 interprets the open pseudo URI 210 (220), converts the open pseudo URI 210 into an internal full URI 230 which corresponds to a real access address of the resource of the thing, and eventually allows a user terminal to access the resource through the internal full URI. The M2M platform 100 can be implemented with a computer hardware server device. The hardware server device may include or be a component of a processing system implemented with one or more processors. The one or more processors may be implemented with any combination of general-purpose microprocessors, microcontrollers or digital signal processors (DSPs). The processing system may also include physical machine-readable media for storing software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing system to perform the various functions described herein. The description of this paragraph applies to M2M platforms 300 and 500 of FIGS. 3 and 5.

As shown in FIG. 1, the internal full URI 230 has a form “<startURI>/<R1>/<R2>/<R3>,” and is distinguished from the open pseudo URI 210 which is an external simple URI.

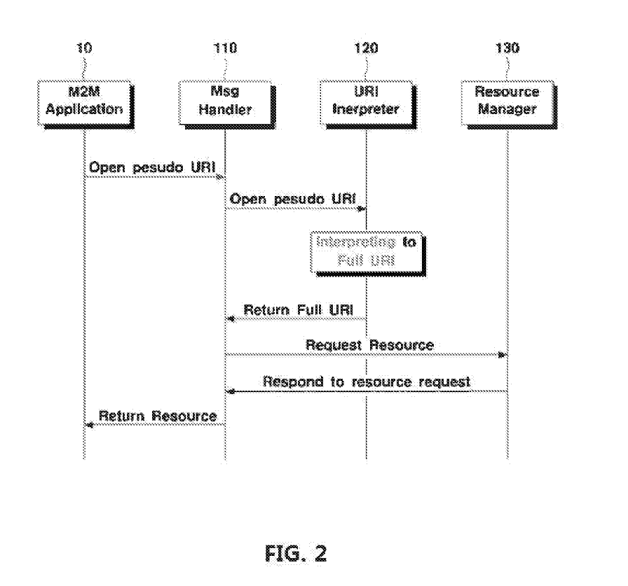

The method of accessing the resource using the open pseudo URI 210 will be described in detail below with reference to FIG. 2. FIG. 2 is a sequence diagram illustrating an operation of the method.

As shown in FIG. 2, an M2M application 10 installed in a user terminal acquires the already disclosed open pseudo URI 210, and requests an access to the resource of the thing by transmitting the open pseudo URI 210 to the M2M platform 100. The user terminal may be an IoT device. The IoT device may include, but is not limited to, a TV, a laptop, a tablet, a mobile phone, a smartphone, a personal digital assistant (PDA), a personal media player PMP), a game console, a digital camera, a computer peripheral device, a communication device (e.g., Bluetooth or Zigbee devices), a hearing aid, a wearable device, other consumer electronics or home appliance products, or any other computing device that can communicate with other IoT devices or computing devices via a wired or wireless communication network.

Then, a message handler 110 of the M2M platform 100 transmits the open pseudo URI 210 received from the M2M application 10 to a URI interpreter 120.

In response to this, the URI interpreter 120 interprets the received open pseudo URI 210 and converts the open pseudo URI 210 into the internal full URI 230 which is a real access address of the resource of the thing. The internal full URI 230 is transmitted from the URI interpreter 120 to the message handler 110.

The message handler 110 requests the corresponding resource by transmitting the internal full URI 230 to a resource manager 130, and receives a response to this request and transmits the response to the M2M application 10.

Accordingly, the M2M application 10 can access the desired resource. The developer of the thing or the IoT service provider can access the resource of the thing using the open pseudo URI 210 in the same way as the M2M application 10.

The message handler 110, the URI interpreter 120 and the resource manager 130 can be implemented with computer hardware devices. For example, the elements 110-130 can include or be a component of a processing system implemented with one or more processors described above with respect to the M2M platform 100.

### Method #2 for Accessing Resource of Thing

FIG. 3 is a view illustrating a concept of a method of accessing a resource of a thing according to another exemplary embodiment. Herein, the resource may include any components or entities (e.g., nodes, data, applications) that form an M2M system. For example, the node includes a server and a gateway in addition to a normal node. This applies to the above-described exemplary embodiment and embodiments which will be described later.

The present exemplary embodiment assumes that there is no open information regarding the resource, the resource of the thing is accessed. However, the described technology is not limited thereto, and can be applied to other embodiments where there is open information regarding the resource.

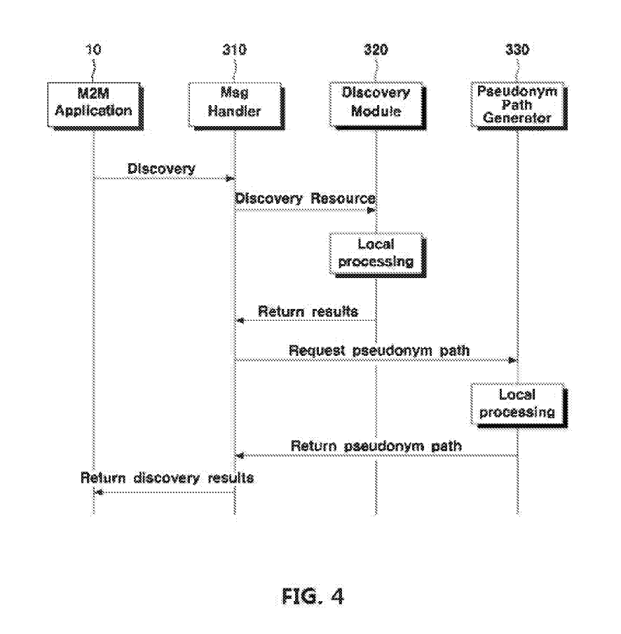

This path may be provided through a resource discovery response to a resource discovery request 410, and a pseudonym path may be provided instead of a real path. This process will be explained in detail with reference to FIG. 4.

As shown in FIG. 4, when an M2M application 10 installed in a user terminal requests an M2M platform 300 to discover a desired resource, a message handler 310 of the M2M platform 300 transmits the request received from the M2M application 10 to a discovery module 320.

In response to this request, the discovery module 320 discovers the resource desired by the M2M application 10, and returns the result of the discovery to the message handler 310.

Then, the message handler 310 requests a pseudonym path regarding the returned resource from a pseudonym path generator 330, and the pseudonym path generator 330 dynamically generates the requested pseudonym path and returns the pseudonym path to the message handler 310.

The message handler 310 transmits the pseudonym path returned from the pseudonym path generator 330 as the result of the resource discovery responding to the resource discovery request of the M2M application 10.

The result of the resource discovery includes the pseudonym path. Referring back to FIG. 3, the M2M application 10 receives a pseudo URI 420 as the result of the resource discovery.

The M2M application 10 may request an access to the resource of the thing by transmitting the received pseudo URI to the M2M platform 300. Then, the M2M platform 300 identifies that the pseudo URI received from the M2M application 10 is the pseudonym path “<PseudonymPath>” (430), and converts the pseudo URI into an internal full URI 440 by changing the pseudonym path to a real path and eventually allows the M2M application 10 to access the resource of the thing.

For example, the M2M platform 300 identifies that the pseudo URI received from the M2M application 10 includes the pseudonym path “<PseudonymPath>” (430), and converts the pseudo URI into the internal full URI 440 by changing the pseudonym path to a real path “<R1>/<R2>” and eventually allows the M2M application 10 to access the resource of the thing.

In the above-described exemplary embodiment, it is assumed that all paths except <startURI> and <targetResource> in the full URI are replaced with the pseudonym path as in an example presented below:

### Example 1

Full URI: <startURI>/<R1>/<R2>/<R3>/<R4>/<targetResource>
Middle URI: <R1>/<R2>/<R3>/<R4>
Target resource: <targetResource>
Full replacement case: <startURI>/abcdefghijklmnop/<targetResource>
PseudonymPath: abcdefghijklmnop
Pseudo URI: <startURI>/abcdefghijklmnop/<targetResource>

### Example 2

Full URI:

<scheme>://In-CSEID.m2 m.myoperator.org/CSE123/myAppX/myContainerY
Pseudo URI:

<scheme>://In-CSEID.m2 m.myoperator.org/CSEBase/myContainerY

### Example 3

Full URI:

<scheme>://In-CSEID.m2 m.myoperator.org/CSE123/myAppX/myContainerY
Pseudo URI:

<scheme>://In-CSEID.m2 m.myoperator.org/some/path/myContainerY

In example 2), “CSE123/myAppX” is replaced with “CSEBase,” and, in example 3), “CSE123/myAppX” is replaced with “some/path.”

However, only a part of the middle path may be replaced with a pseudonym path as explained below. This may apply to an embodiment in which a service provider wants to disclose only a part of a resource topology structure to the M2M application 10.
Full URI: <startURI>/<R1>/<R2>/<R3>/<R4>/<targetResource>
Middle URI: <R1>/<R2>/<R3>/<R4>
Target resource: <targetResource>
Partial replacement case:
   <startURI>/fghmnop/<R3>/<R4>/<targetResource>

Furthermore, all paths except <startURI> may be replaced with the pseudonym path as follows:

### Example 1

Full URI: <startURI>/<R1>/<targetResource>
Pseudo URI: <startURI>/<abc>

### Example 2

Full URI:

<scheme>://In-CSEID.m2 m.myoperator.org/CSE123/myAppX/myContainerY
Pseudo URI:

<scheme>://In-CSEID.m2 m.myoperator.org/sc07

In the above examples, <startURI> refers to a root of a resource structure of an entity, and is allocated a unique absolute address.

The full URI corresponds to a hierarchical URI since the full URI hierarchically indicates parent-child chain relations regarding <targetResource> according to a resource structure.

On the other hand, the pseudo URI corresponds to a non-hierarchical URI since the pseudo URI includes a part which does not hierarchically indicate the parent-child chain relations regarding <targetResource>.

In the case of the full URI, all of the parts forming the URI indicate hierarchical addresses, but, in the case of the pseudo URI, a part which does not indicate a hierarchical address is included in the URI. This part has various depths as described in the above examples, and it may not be known in advance which address is indicated by this part. In this case, it is interpreted which address is indicated by the corresponding part and it should be known what is the real address of <targetResource>.

When there is no middle URI as in the following case, the technique of the present exemplary embodiment can be applied.
Full URI: <startURI>/<targetResource>
Pseudo URI: <startURI>/<def>

The above-described exemplary embodiment assumes that the M2M application 10 accesses the resource of the thing using the pseudo URI which is a non-hierarchical URI. However, the described technology is not limited thereto. The M2M application 10 may access the resource of the thing using the full URI which is a hierarchical address. This is because The M2M platform 300 or other entities allocate both the hierarchical URI and the non-hierarchical URI to the resources.

In generating the pseudonym path proposed above, the ID of the M2M application 10 may be used. In this case, to access the same resource, different M2M applications 10 may generate different pseudonym paths.
Multiple clients case for the same target <targetResource>
URI to Application A: <startURI>/abcdefghijklmnop/<targetResource>
URI to Application B: <startURI>/238dksu39830dkd/<targetResource>

In the above-described exemplary embodiments, it is assumed that <startURI> of the pseudo URI is identical to <startURI> of the full URI. However, this is merely an example. The part <startURI> of the full URI may be replaced with a non-hierarchical address.

Furthermore, the pseudo URI may be changed when the full URI is changed or may be changed according to circumstances even when the full URI is not changed. The latter case may be necessary for tightening security.

In addition, there may be no limitation to what allocates/assigns the URI. For example, any of the M2M platform or other entities (nodes, data, applications, etc.) forming the M2M system as well as the IoT service provider may allocate/assign the URI. In this embodiment, there may be a limitation to the range of allocation/assignment. Furthermore, an entity to allocate/assign the pseudo URI and an entity to allocate/assign the full URI may be distinguished from each other, and there may be an entity which can allocate/assign both the pseudo URI and the full URI.

The message handler 310, the discovery module 320 and the pseudonym path generator 330 can be implemented by hardware devices. For example, the elements 310-330 can include or be a component of a processing system implemented with one or more processors described above with respect to the M2M platform 100.

### Method #3 for Accessing Resource of Thing

FIG. 5 is a view illustrating a concept of a method of accessing a resource of a thing according to another exemplary embodiment. The method of FIG. 5 is substantially the same as “Method #1 in that the resource of the thing (device) is accessed using an open pseudo URI 610 which is an open pseudo access address.

However, the present embodiment is different from the embodiment of “Method #1 in that an M2M proxy server 620 rather than an M2M platform 500 converts the open pseudo URI 610 into an internal full URI 630 corresponding to a real access address of the resource of the thing, and the user terminal accesses the resource through the internal full URI 630.

Other operations and/or features relating to a URI are described in ONEM2M Technical Specification published by oneM2M Partners Type 1 on Aug. 1, 2014 as Document Number “oneM2M-TS-0001-V-2014-08” and Document Name “oneM2M Functional Architecture Baseline Draft,” which is hereby incorporated by reference. See, for example, Sections 9 “Resource Management” and 9.1 “General Principles.”

While the inventive technology has been described with respect to the accompanying drawings, it will be understood by those of ordinary skill in the art that the present invention is not limited to the above-described exemplary embodiments, and various changes in form and details may be made therein without departing from the spirit and scope of the present invention as defined by the following claims. In addition, various changes should not be interpreted as being separated from the technical idea or scope of the present invention.

What is claimed is:

1. A method of allocating a universal resource identifier (URI) to a resource in a computer network, the method comprising:
allocating, at a hardware server device, a first type of URI to a first resource; and
additionally allocating, at the hardware server device, a second type of URI to the first resource.

2. The method of claim 1, wherein the first type of URI and the second type of URI identify the first resource.

3. The method of claim 1, wherein the first type of URI comprises a hierarchical URI, and wherein the second type of URI comprises a non-hierarchical URI.

4. The method of claim 3, wherein the hierarchical URI comprises a URI which is based on the chain of child-parent relations.

5. The method of claim 3, wherein the non-hierarchical URI comprises a URI which is not based on the chain of child-parent relations.

6. The method of claim 1, wherein a root of the first type of URI is identical to a root of the second type of URI.

7. The method of claim 1, wherein the first resource is accessed using the first type of URI or the second type of URI.

8. The method of claim 1, wherein the first resource comprises at least one of the following: a node, a gateway, a server, an application, and data.

9. The method of claim 1, further comprising:
allocating the first type of URI to a second resource; and
additionally allocating the second type of URI to the second resource.

10. The method of claim 1, wherein the hardware server device comprises a machine to machine (M2M) platform server.

11. The method of claim 1, wherein allocating the second type of URI comprises converting the first type of URI to a real access address of the first resource to obtain the second type of URI.

12. A method for accessing a resource in a computer network, the method comprising:
acquiring a universal resource identifier (URI) of the resource from a hardware server device; and
accessing the resource based on the acquired URI via the computer network,
wherein the acquired URI of the resource is a first type of URI or a second type of URI.

13. The method of claim 12, wherein the first type of URI comprises a hierarchical URI, and wherein the second type of URI comprises a non-hierarchical URI.

14. The method of claim 13, wherein the hierarchical URI comprises a URI which is based on the chain of child-parent relations.

15. The method of claim 13, wherein the non-hierarchical URI comprises a URI which is not based on the chain of child-parent relations.

16. The method of claim 12, wherein a root of the first type of URI is identical to a root of the second type of URI.

17. A system for allocating a universal resource identifier (URI) to a resource in a computer network, the system comprising:
a memory device configured to store a plurality of URIs; and
a hardware processor device being in data communication with the memory device and configured to allocate a first type of URI to a first resource and additionally allocate a second type of URI to the first resource.

18. The system of claim 17, wherein the hardware processor device is further configured to control the memory device to store the allocated first type of URI and second type of URI.

19. A device for accessing a resource in a computer network, the device comprising:
a hardware processor device configured to acquire a universal resource identifier (URI) of the resource from a hardware server device and access the resource based on the acquired URI via the computer network; and
a memory device being in data communication with the hardware processor device and configured to store the acquired URI of the resource,
wherein the acquired URI of the resource is a first type of URI or a second type of URI.

20. The device of claim 19, wherein the first type of URI comprises a hierarchical URI which is based on the chain of child-parent relations, and wherein the second type of URI comprises a non-hierarchical URI which is not based on the chain of child-parent relations.
